(19) United States
(12) Patent Application Publication
(10) Pub. No.: US 2008/0136340 A1
(43) Pub. Date: Jun. 12, 2008

(54) Plasma display and controller thereof

(76) Inventor: Sang-Young Lee, Suwon-si (KR)

Correspondence Address: Robert E. Bushnell;Suite 300, 1522 K Street, N.W., Washington, DC, 20005-1202, US

(21) Appl. No.: 11/826,951

(22) Filed: Jul. 19, 2007

(30) Foreign Application Priority Data
Dec. 8, 2006 (KR) 10-2006-0124593

(51) Int. Cl. G09G 3/28; G05F 1/00

(52) U.S. Cl. 315/169.4; 323/282

(57) ABSTRACT

A controller used for a plasma display and a plasma display having the controller includes: a power supply including a first switch coupled to a primary of a transformer, the primary of the transformer supplying power to a secondary of the transformer according to an operation of the first switch; a feedback circuit to generate a feedback signal according to a voltage level of a reference voltage corresponding to a first voltage outputted to an output terminal connected to the secondary of the transformer; a switching controller to generate a switching control signal to control an ON/OFF operation of the first switch according to the feedback signal; and a reference voltage controller to compare the voltage level of the reference voltage with a predetermined voltage level and to control the voltage level of the reference voltage according to the comparison result.

### CLAIMS OF PRIORITY

This application makes reference to, incorporates the same herein, and claims all benefits accruing under 35 U.S.C.§119 from an application for PLASMA DISPLAY AND CONTROLLER THEREOF earlier filed in the Korean Intellectual Property Office on the 8^{th} day of December 2006 and there duly assigned Serial No. 10-2006-0124593.

### BACKGROUND OF THE INVENTION

1. Field of the Invention

The present invention relates a plasma display and a controller for the plasma display.

2. Description of the Related Art

A plasma display displays characters or images by using a plasma generated by a gas discharge, in which hundreds of thousands to millions of pixels (discharge cells) are arranged in a matrix form according to its size. Plasma displays are divided into DC plasma displays and AC plasma displays according to a supplied driving voltage waveform and a structure of the discharge cells.

In a DC plasma display, electrodes formed on a panel are exposed to a discharge space, so while a voltage is being supplied, current flows as is in the discharge space, for which, thus, a resistor is needed to limit the current. In an AC plasma display, because a dielectric layer covers the electrodes on the panel, a capacitance component is naturally formed to limit current and the electrodes are protected against an impact of ions during a discharge, and accordingly, an AC plasma display has a long life span as compared with a DC plasma display.

Generally, a plasma display includes a power supply for supplying various high voltages, e.g., a sustain discharge voltage Vs, an address voltage Va, a reset voltage Vset, and a scan voltage, etc., to a driving circuit for a plasma discharge and for supplying a low voltage to other circuit units, namely, an image processing unit, a fan, an audio unit, and a control circuit unit, etc.

In general, the power supply is commonly implemented as a switching mode power supply unit. The switching mode power supply unit includes a resistor for guaranteeing accuracy of an output voltage Vo outputted to an output terminal; an operator manually controls a resistance value of the switching mode power supply unit during a manufacturing process. In this case, the operator may make a mistake, which results in degradation of picture quality of the plasma display placed on the market as a finished product. In addition, although no problem arises during the process of manufacturing the switching mode power supply unit, the characteristics of elements may change due to aging of the elements as the plasma display is driven for more than a certain time period and due to changes in an external environment, such as temperature or humidity. As a result, even after the plasma display is placed on the market as a finished product, measures must be taken to ensure accuracy of the output voltage Vo of the switching mode power supply unit.

### SUMMARY OF THE INVENTION

An exemplary embodiment of the present invention provides a controller to supply a driving voltage to drive a plasma panel, the controller including: a power supply including a first switch coupled to a primary of a transformer, the primary of the transformer supplying power to a secondary of the transformer according to an operation of the first switch; a feedback circuit to generate a feedback signal according to a voltage level of a reference voltage corresponding to a first voltage outputted to an output terminal connected to the secondary of the transformer; a switching controller to generate a switching control signal to control an ON/OFF operation of the first switch according to the feedback signal; and a reference voltage controller to compare the voltage level of the reference voltage with a predetermined voltage level and to control the voltage level of the reference voltage according to the comparison result.

The reference voltage controller preferably includes: a Pulse Width Modulation (PWM) generator to compare the voltage level of the reference voltage with the predetermined voltage level, and to change a duty cycle ratio of an outputted pulse string according to the comparison result; an integrator to output a DC voltage corresponding to the duty cycle ratio of the pulse string; a second switch controlled to be turned ON or OFF according to a voltage level of the DC voltage outputted from the integrator, and having one terminal connected to a first point at which a second voltage proportional to the reference voltage is detected; a first resistor connected between another terminal of the second switch and a ground terminal; and a second resistor connected between the first point and the ground terminal. The reference voltage controller preferably further includes: a first diode having one terminal connected to an output terminal of the PWM generator, the first diode rectifying the pulse string.

The PWM generator preferably includes: a reference voltage storage unit to store the predetermined voltage; a comparator to compare the predetermined voltage with the reference voltage and to output a signal according to the comparison result; a pulse string generator to generate the pulse string; and a duty cycle ratio controller to change the duty cycle ratio of the pulse string according to the output signal of the comparator.

The duty cycle ratio controller preferably increases the duty cycle ratio of the pulse string in response to the predetermined voltage being larger than the reference voltage, and the duty cycle ratio controller reduces the duty cycle ratio of the pulse string in response to the predetermined voltage being smaller than the reference voltage.

The integrator preferably includes: a third resistor having one end connected to another terminal of the first diode; a fourth resistor having one end connected to another end of the third resistor and the fourth resistor having another end connected to the ground terminal; and a first capacitor having one end connected to a second point, the second point being a junction of the third and fourth resistors, and the first capacitor having another end connected to the ground terminal.

The controller preferably further includes: a fifth resistor having one end connected to the second point and another end connected to a control electrode of the first switch, the fifth resistor canceling noise of an output signal from the integrator and transferring the noise-canceled signal to a control terminal of the first switch.

The voltage at the first point preferably increases when the second switch is turned on.

The feedback circuit unit preferably includes: a sixth resistor having one end connected to the output terminal; a seventh resistor having one end connected to a junction of the output terminal and the first resistor; a photodiode having a terminal connected to another end of the seventh resistor; a phototransistor to transfer the feedback signal corresponding to an amount of current inputted to the photodiode to the switching controller; a second capacitor having one end connected to another end of the sixth resistor and the second capacitor having another end connected to another terminal of the photodiode; a shunt regulator having a reference terminal connected to a third point, the third point being a junction of the second capacitor and the first resistor and the shunt regulator having another terminal connected to a junction of the second capacitor and the photodiode; and an eighth resistor having one end connected to the third point and the eighth resistor having another end connected to still another terminal of the shunt regulator and the first point.

The reference voltage is preferably a voltage at the third point. The reference voltage is preferably related to the voltage at the first point.

Another embodiment of the present invention provides a plasma display including: a Plasma Display Panel (PDP) including a plurality of first electrodes, a plurality of second electrodes, and a plurality of third electrodes formed to cross the first and second electrodes; first to third drivers to respectively drive the pluralities of first to third electrodes; a power supply to convert an input voltage to a DC voltage and to generate a plurality of driving voltages to respectively drive the first to third electrodes; and a controller including a first switching mode power supply unit to supply a control signal to the drivers and to supply a first voltage to the first driver; the first switching mode power supply unit includes:

a power supply including a first switch coupled to a primary of a transformer, the primary of the transformer supplying power to a secondary of the transformer according to an operation of the first switch; a feedback circuit to generate a feedback signal according to a voltage level of a reference voltage corresponding to the first voltage outputted to an output terminal connected to the secondary of the transformer; a switching controller to generate a switching control signal to control an ON/OFF operation of the first switch according to the feedback signal; and a reference voltage controller to compare the voltage level of the reference voltage with a predetermined voltage level and to control the voltage level of the reference voltage according to the comparison result.

The controller preferably drives the PDP according to a reset period, an address period and a sustain period; and the first driver supplies the first voltage to a cell of the PDP which is not being addressed during the address period.

The controller preferably further includes second to Nth switching mode power supply units respectively corresponding to the number of the plurality of driving voltages, the second to Nth switching mode power supply units each being identical to the first switching mode power supply unit; the controller respectively supplies second to Nth voltages outputted from the second to the Nth switching mode power supply units to the first to third drivers.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a schematic block diagram of a plasma display according one exemplary embodiment of the present invention.

FIG. 2 is a circuit diagram of a switching mode power supply unit of a power supply according to an exemplary embodiment of the present invention.

FIG. 3 is a schematic block diagram of a Pulse Width Modulation (PWM) generator according to the exemplary embodiment of the present invention.

FIGS. 4(a)-4(c) are views of an example of an output signal of a PWM generator and corresponding voltage waveforms of each part of a reference voltage controller according to the exemplary embodiment of the present invention.

FIGS. 5(a)-5(c) are views of another example of an output signal of the PWM generator and corresponding voltage waveforms of each part of a reference voltage controller according to the exemplary embodiment of the present invention.

FIG. 6 is a schematic block diagram of a plasma display according another exemplary embodiment of the present invention.

### DETAILED DESCRIPTION OF THE INVENTION

The present invention has been made in an effort to provide a plasma display having advantages of being driven with an accurate driving voltage, and a controller used therefor.

In the following detailed description, only certain exemplary embodiments of the present invention have been shown and described, simply by way of illustration. As those skilled in the art would realize, the described embodiments may be modified in various different ways, all without departing from the spirit or scope of the present invention.

In order to clarify the present invention based on drawings, parts unrelated to the description have been omitted and like reference numerals designate like elements throughout the specification.

It will be understood that, in the entire specification, when one portion is connected to another portion, it can be directly connected to another portion or it can be electrically connected with intervening elements present therebetween. When a part ‘includes’ an element, it means that it may include a different element, rather than excluding the different element, unless otherwise specified.

A plasma display and a controller used for the plasma display according to the exemplary embodiment of the present invention are described below with reference to the accompanying drawings.

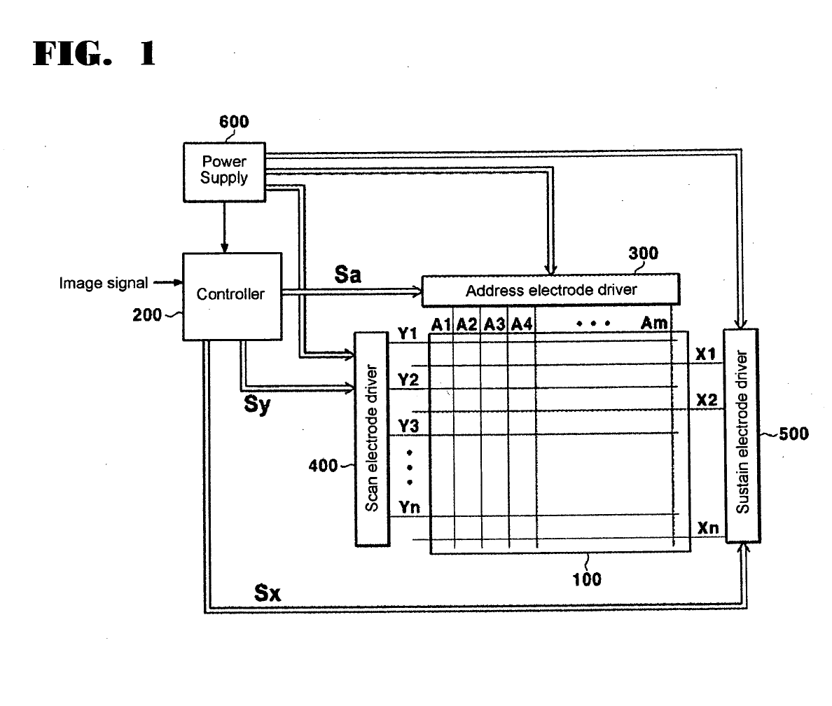

First, the structure of the plasma display according to one exemplary embodiment of the present invention is described in detail as follows with reference to FIG. 1.

FIG. 1 is a schematic block diagram of a plasma display according one exemplary embodiment of the present invention.

As shown in FIG. 1, the plasma display according to one exemplary embodiment of the present invention includes a Plasma Display Panel (PDP) 100, a controller 200, an address electrode driver 300, a scan electrode driver 400, a sustain electrode driver 500, and a power supply 600.

The PDP 100 includes a plurality of address electrodes A1˜Am extending in a column direction and a plurality of sustain electrodes X1˜Xn and scan electrodes Y1˜Yn extending in a row direction, making pairs each other. The sustain electrodes X1˜Xn are formed corresponding to the scan electrodes Y1˜Yn, and in general, one end of each electrode thereof are commonly connected together. The PDP 100 includes a substrate (not shown) on which the sustain electrodes X1˜Xn and the scan electrodes Y1˜Yn are arranged and a substrate (not shown) on which the address electrodes A1˜Am are arranged. The two substrates are disposed to face each other with a discharge space therebetween such that the scan electrodes Y1˜Yn and the address electrodes A1˜Am and the sustain electrodes X1˜Xn and the address electrodes A1˜Am cross each other. A discharge space at each crossing of the address electrodes A1˜Am, the sustain electrodes X1˜Xn, and the scan electrodes Y1˜Yn forms a discharge cell. The structure of the PDP 100 shows one example, and a panel with a different structure to which driving waveforms can be supplied (to be described) can be applicable in the present invention.

The controller 200 receives an external image signal and outputs an address electrode drive control signal Sa, a sustain electrode drive control signal Sx, and a scan electrode drive control signal Sy. The controller 200 drives the PDP by dividing a single frame into a plurality of sub-fields, and each field includes a reset period, an address period, and a sustain period in terms of a temporal operation change. The controller 200 generates a scan high voltage (Vscan_h) to be supplied to a cell that is not addressed during the address period by using a DC voltage received from the power supply 600, and transfers it to the scan electrode driver 400 or the sustain electrode driver 500.

The address electrode driver 300 receives the address electrode drive control signal Sa from the controller 200 and supplies a display data signal for selecting discharge cells to be displayed to each address electrode.

The scan electrode driver 400 receives the scan electrode drive control signal from the controller 200 and supplies a driving voltage to the scan electrodes Y1˜Yn.

The sustain electrode driver 500 receives the sustain electrode drive control signal Sx from the controller 200 and supplies a driving voltage to the sustain electrodes X1˜Xn.

The power supply 600 supplies power required for driving the plasma display to the controller 200 and respective drives 300, 400, and 500.

A switching mode power supply unit included in the controller 200 and used for generating the scan high voltage Vscan_h will be described as follows.

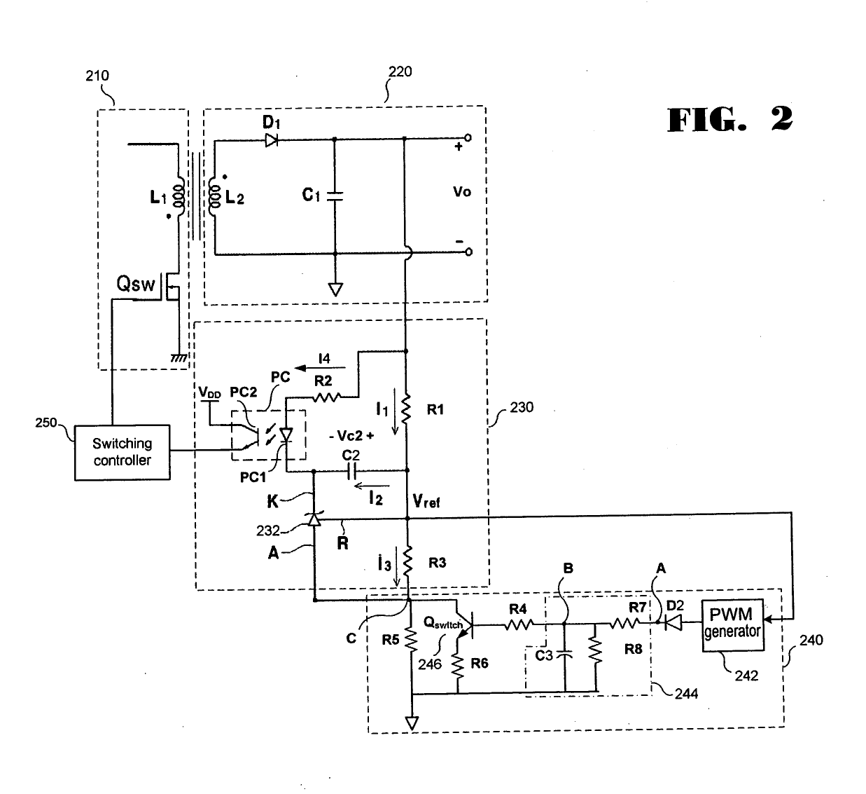

FIG. 2 is a circuit diagram of a switching mode power supply unit according to an exemplary embodiment of the present invention.

In FIG. 2, an output unit 220, only the construction of a feedback circuit unit 230 and a reference voltage controller 240 are shown in detail and other elements are shown schematically or have been omitted.

As shown in FIG. 2, the switching mode power supply unit according to the exemplary embodiment of the present invention includes a power supply 210, the output unit 220, a feedback circuit unit 230, a reference voltage controller 240, and a switching controller 250.

The power supply 210 includes a primary coil L1 of a transformer and a switching transistor Qsw having a drain connected to the primary coil L1. The power supply 210 supplies an input DC voltage to a secondary side of the transformer, namely, to the output unit 220, according to a duty ratio of the switching transistor Qsw.

The output unit 220 includes a diode D1 having an anode connected to one end of a secondary coil L2 of the transformer and a capacitor C1 connected between a cathode of the diode D1 and a ground, and the other end of the secondary coil L2 of the transformer is connected to the ground. The voltage supplied across the capacitor C1 is an output voltage Vo.

The feedback circuit unit 230 includes a resistor R1 having one end connected to the diode D1, a resistor R2 having one end connected to one end of the resistor R1, a capacitor C₂ having one end connected to the other end of the resistor R1, a photodiode PC1 having an anode connected to the other end of the resistor R2 and a cathode connected to the other end of the capacitor C₂, a phototransistor PC2 forming a photocoupler PC together with the photodiode PC1 and connected to the switching controller 250 for controlling an ON/OFF operation of the switching transistor Qsw, a shunt regulator 232 having a reference terminal (R) connected to a junction of the resistor R1 and the capacitor C₂ and a cathode (K) connected to a junction of a cathode of the photodiode PC1 and the capacitor C₂, and a resistor R3 having one end connected to the reference terminal (R) of the shunt regulator 232 and the other end connected to a junction (C) of an anode (A) of the shunt regulator 232 and the reference voltage controller 240.

As the reference voltage Vref inputted to a reference terminal of the shunt regulator 232 changes according to the output voltage Vo of the output unit 220, an amount of current flowing to the photodiode PC1 after passing through the resistor R2 changes, and accordingly, a signal transferred to the switching controller 250 through the phototransistor PC2 also changes.

The switching controller 250 determines whether to turn the switching transistor Qsw included in the power supply 210 on or off according to a feedback signal from the feedback circuit unit 230.

When the output voltage Vo outputted to the output unit 220 is sustained uniformly, an amount of current I1 flowing at the resistor R1 and an amount of current I3 flowing at the resistor R3 are equal, and accordingly, an amount of current I3 flowing through the capacitor C₂ becomes zero. When the reference voltage Vref is the same as a pre-set reference voltage, the voltage at the junction (C) with the reference voltage controller 240 does not change, so the reference voltage Vref is also sustained as is. The reference voltage Vref is set to be the same as a reference voltage of the side of the anode (A) of the shunt regulator 232. Namely, when the reference voltage is the same as the pre-set reference voltage, current does not flow from the cathode (K) of the shunt regulator 232 to the anode (A), and accordingly, an amount of current I4 flowing at the resistor R2 is zero, so the photocoupler PC is not operated.

A description of the influence of the operation of the reference voltage controller 240 has been omitted and the driving of the feedback circuit unit 230 when the output voltage Vo changes is described as follows.

The reference voltage Vref relates to the output voltage Vo. Thus, when the output voltage increases, the reference voltage increases, and when the output voltage V0 decreases, the reference voltage also decreases. When the reference voltage Vref increases, an amount of current flowing from the cathode (K) to the anode (A) of the shunt regulator 232 increases. Accordingly, a current I2 flows through the capacitor C₂, increasing the voltage Vc2 supplied across the capacitor C₂. Namely, the voltage at the junction of the cathode (K) of the shunt regulator 232 and the capacitor C₂ is Vref−V_{c2}. The voltage supplied to the junction of the resistors R1 and R2 is Vref+(R1*I1), which is greater than the reference voltage Vref, and thus, a current I4 flows through the R2 so as to be inputted to the photodiode PC1. The photodiode PC1 drives the phototransistor PC2 according to the amount of current I4 and transfers it to the switching controller 250. Conversely, when the reference voltage Vref is small, the amount of current flowing from the cathode (K) to the anode (A) of the shunt regulator is reduced. Accordingly, the current I2 which has been flowing through the capacitor C₂ is reduced and thus the voltage Vc2 which has been supplied across the capacitor C₂ is reduced. Namely, the voltage Vref−V_{c2} at the junction of the cathode (K) of the shunt regulator 232 and the capacitor C₂ increases. Because the reference voltage Vref has been reduced, the voltage Vref+(R1*I1) supplied to the junction of the resistors R1 and R2 is also reduced, and accordingly, the amount of current I4 inputted to the photodiode PC1 through the resistor R2 is reduced.

The construction of the feedback circuit unit 230 for feeding the information on the output voltage Vo back to the switching controller 250 is merely an example, and as a matter of course, a circuit different from the above-described circuit can be also applied.

The reference voltage controller 240 includes a Pulse Width Modulation (PWM) generator 242, an integrator 244, and a switching transistor Qswitch 246.

The PWM generator 242 receives the reference voltage and outputs a pulse string which has a different pulse width according to a voltage level of the reference voltage Vref. The pulse string outputted from the PWM generator 242 is rectified through a diode D2 whose anode is connected to an output terminal of the PWM generator 242.

The integrator 244 includes a resistor R7 having one end connected to a cathode of the diode D2, a resistor R8 having one end connected to the other end of the resistor R7, and a capacitor C3 having one end connected to a junction of the resistors R7 and R8 and the other end connected to the other end of the resistor R8.

The integrator 244 receives the pulse string which has been rectified through the diode D2 after having been outputted from the PWM generator 242, and outputs a voltage in proportion to the duty cycle ratio of the pulse string.

The switching transistor 246 is driven by voltage outputted from the integrator 244. Namely, the switching transistor 246 is turned on when an output voltage of the integrator 244 after removing its noise component and lowering its voltage level by the resistor R4 is higher than a turn-on voltage of the switching transistor 246, and the switching transistor 246 is turned off when that voltage is lower than the turn-on voltage of the switching transistor 246.

One end of the switching transistor 246 is connected to a point ‘C’, a junction with the feedback circuit unit 230, so that the current I3 at the resistor R3 of the feedback circuit unit 230 flows to the ground terminal through the resistor R5 when the switching transistor 246 is turned off, and through the resistors R5 and R6 when the switching transistor 246 is turned on.

When the duty cycle ratio of the output pulse of the PWM generator 242 is greater than a predetermined rate, the switching transistor 242 is turned on, and accordingly, the voltage from the ground terminal up to the point ‘C’ increases. The increase in the voltage at the point ‘C’ means that the reference voltage Vref increases, and because the reference voltage Vref is an input voltage of the reference terminal (R) of the shunt regulator 232, the signal outputted to the switching controller 250 through the photocoupler PC changes as mentioned above regarding the operation of the feedback circuit unit 230.

Namely, in order to overcome the shortcomings of the related art plasma display that cannot implement desired picture quality because the voltage level of the reference voltage Vref changes due to the change in characteristics of the elements resulting from aging of the elements and the change in the external environment such as temperature or humidity, in the present exemplary embodiment, the switching mode power supply unit controls the voltage level of the reference voltage Vref by using the reference voltage controller 240 to vary the feedback signal through the photocoupler PC to thereby precisely control the output voltage Vo.

In the exemplary embodiment of the present invention, the voltage level compensation is only effected by increasing the voltage level of the reference voltage Vref by using the reference voltage controller 240. This is because, in most cases, the resistance values of the resistors R3 and R5 are detected to be lowered due to the change in the characteristics of the elements as mentioned above.

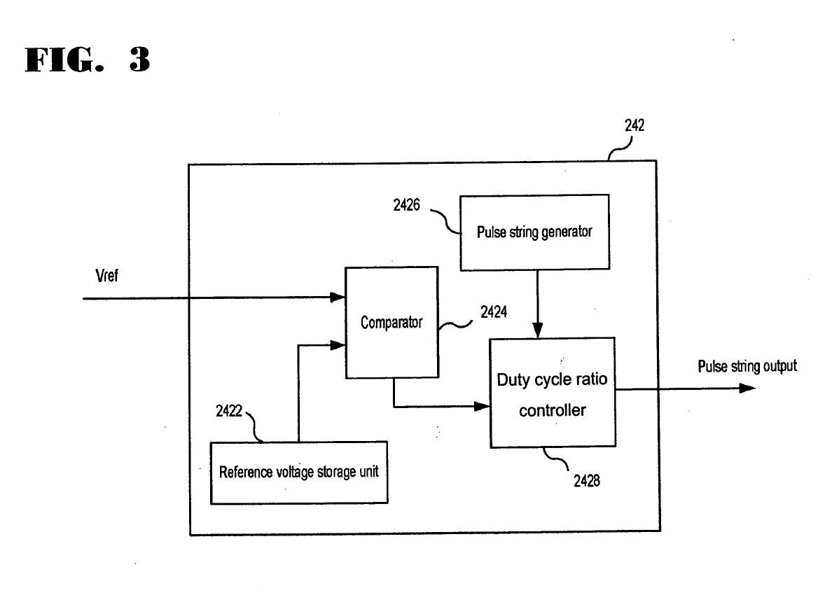

The PWM generator 242 of the reference voltage controller 240 according to the exemplary embodiment of the present invention is described as follows with reference to FIG. 3.

FIG. 3 is a schematic block diagram of the PWM generator 242 according to an exemplary embodiment of the present invention.

As shown in FIG. 3, the PWM generator 242 according to the exemplary embodiment of the present invention includes a reference voltage storage unit 2422, a comparator 2424, a pulse string generator 2426, and a duty cycle ratio controller 2428.

The reference voltage storage unit 2422 stores a predetermined reference voltage for implementing optimum picture quality.

The comparator 2424 receives a voltage and the reference voltage Vref stored in the reference voltage storage unit 2422, and transfers a voltage difference between the two voltages to the duty cycle ratio controller 2428.

The pulse string generator 2426 generates a pulse string and transfers it to the duty cycle ratio controller 2428. The pulse string refers to a group of pulses continuously toggled at a certain frequency.

The duty cycle ratio controller 2428 controls the duty cycle ratio of the pulse string inputted from the pulse string generator 2426 according to the voltage difference information inputted from the comparator 2424.

The duty cycle ratio of the pulse string generated by the pulse string generator 2426 is set to be quite small, and the duty cycle ratio controller 2428 controls the duty cycle ratio of the pulse string so as to be proportional to the voltage difference information inputted from the comparator 2424 and outputs it to the comparator 244.

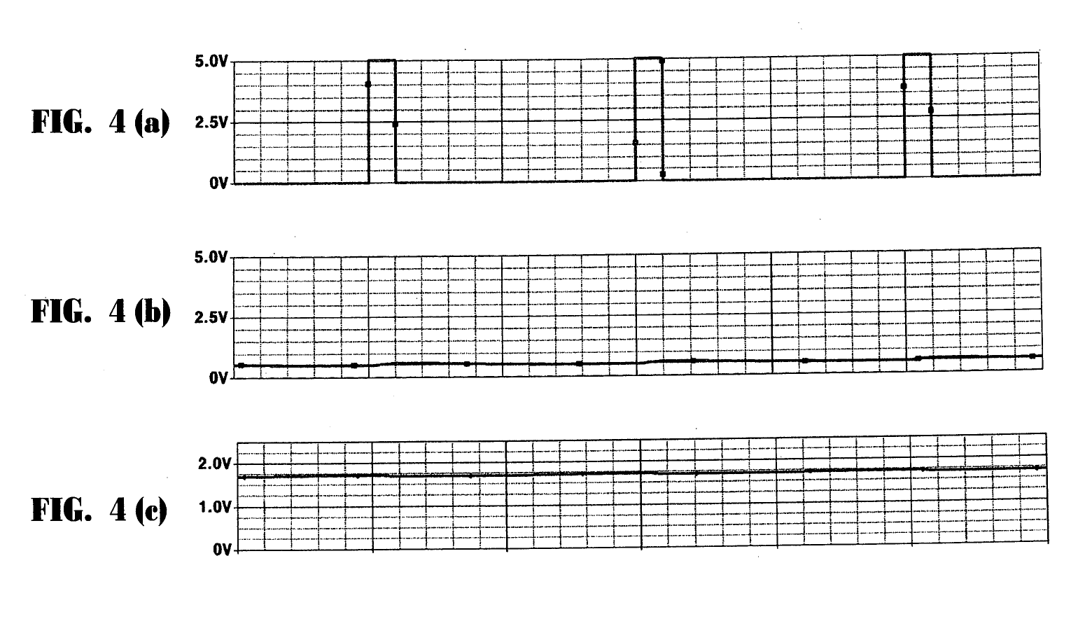

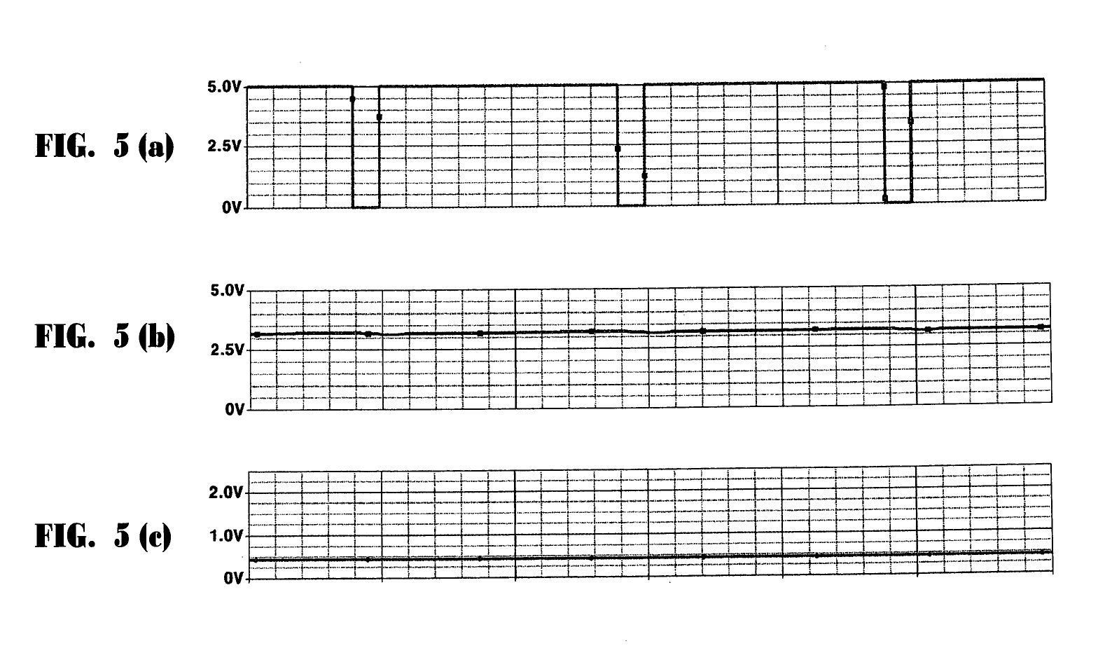

Voltage waveforms at each part of an output terminal (A) of the PWM generator 242, an output terminal (B) of the integrator 244, and the junction (C) of the reference voltage controller 240 and the feedback circuit unit 230, according to the output signal of the duty cycle ratio controller 2428 are described as follows with reference to FIGS. 4(a)-4c) and 5(a)-5(c).

FIGS. 4(a)-4(c) are views of one example of an output signal of the PWM generator and corresponding voltage waveforms of each part of the reference voltage controller.

FIG. 4(a) is a voltage waveform appearing right after the voltage of the output terminal (A) of the PWM generator 242 has passed through the diode D2 that performs rectifying operation, in which a duty cycle ratio of the pulse string outputted from the duty cycle ratio controller 2428 is small. Namely, a voltage difference between the predetermined reference voltage stored in the reference voltage storage unit 2424 of the PWM generator 242 and the reference voltage Vref is smaller than a pre-set value.

FIG. 4(b) is a voltage waveform at the output terminal (B) of the integrator 244, which has a low voltage level corresponding to the duty cycle ratio of the pulse string inputted to the integrator 244.

FIG. 4(c) is a voltage waveform at the junction (C) of the reference voltage controller 240 and the feedback circuit unit 230. Because the switching transistor 246 is in an OFF state because of the low voltage level of the output terminal (B) of the integrator 244, current flowing to the point ‘C’ flows to the ground terminal through the resistor R5, and at this time, the voltage level of the point ‘C’ is relatively low compared with the voltage level when the switching transistor 246 is turned on.

FIGS. 5(a)-5(c) are views of another example of an output signal of the PWM generator and corresponding voltage waveforms of each part of the reference voltage controller.

FIG. 5(a) is a voltage waveform appearing right after a voltage of the output terminal (A) of the PWM generator 242 has passed through the diode D2 that performs rectifying operation, in which a duty cycle ratio of the pulse string outputted from the duty cycle ratio controller 2428 is large. Namely, a voltage difference between the predetermined reference voltage stored in the reference voltage storage unit 2424 of the PWM generator 242 and the reference voltage Vref is greater than the pre-set value.

FIG. 5(b) is a voltage waveform of the output terminal (B) of the integrator 244, which has a relatively high voltage level, corresponding to the duty cycle ratio of the pulse string inputted to the integrator 244, compared with the voltage level of FIG. 4(b).

FIG. 5(c) is a voltage waveform of the junction (C) of the reference voltage controller 240 and the feedback circuit unit 230. Because the switching transistor 246 is in an ON state because of the high voltage level of the output terminal (B) of the integrator 244, the current flowing at the point ‘C’ flows to the ground terminal through the resistor R6. Accordingly, the voltage level at the point ‘C’ is relatively high compared with the voltage level when the switching transistor 246 is turned off.

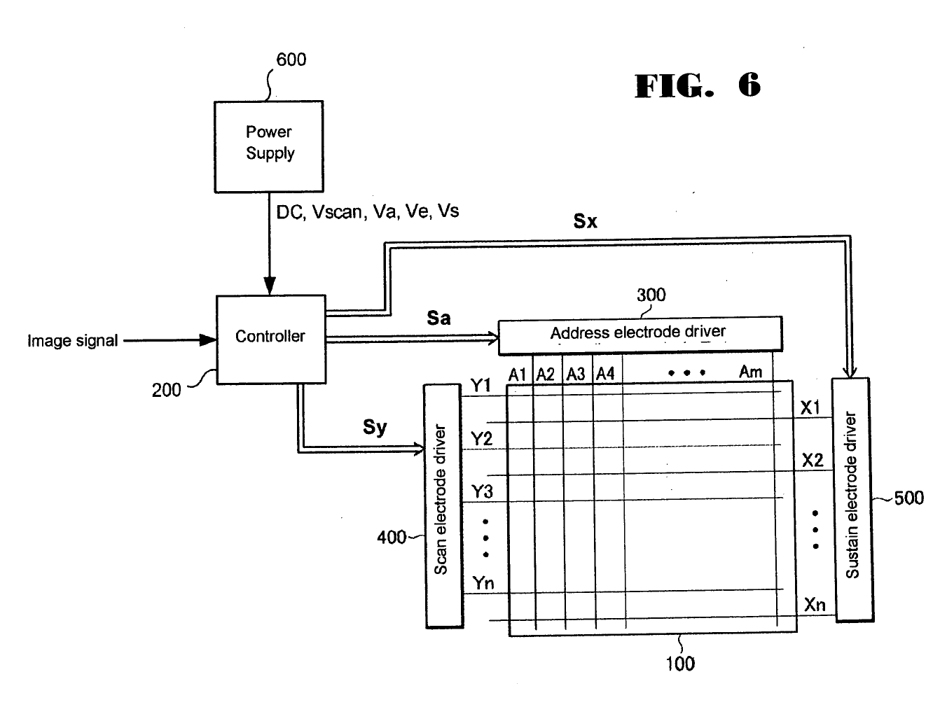

Unlike the plasma display according to one exemplary embodiment of the present invention of FIG. 1 in which the switching mode power supply unit of the controller 200 is used to generate the scan high voltage (Vscan_h), some other driving voltages Va, Ve, Vs, and Vscan generated by the power supply 600 can be transferred to the controller 200 and the switching mode power supply unit can be provided at each driving voltage to thus generate an accurate driving voltage. A plasma display according to another exemplary embodiment of the present invention is shown in FIG. 6.

FIG. 6 is a schematic block diagram of a plasma display according to another exemplary embodiment of the present invention.

With reference to FIG. 6, a description of the same elements as those of the plasma display according to the exemplary embodiment of the present invention as shown in FIG. 1 has been omitted and only different elements are explained below.

In another exemplary embodiment of the present invention as shown in FIG. 6, the power supply 600 generates power required for driving the plasma display and transfers it to the controller 200. The controller 200 receives such driving voltages Vs, Va, Vscan, and Ve, as those generated by the power supply 600 and directly transferred to the respective drives 300, 400, and 500 in the plasma display according to one exemplary embodiment of the present invention of FIG. 1, as well as a DC voltage for generating the scan high voltage Vscan_h from the power supply 600.

The controller 200 includes the switching mode power supply unit of FIG. 2 corresponding to the number of voltages received from the power supply 600. Each switching mode power supply unit is used to generate the scan high voltage Vscan_h, and the reference voltage controller (240 in FIG. 2) generates the accurate driving voltages Vs, Va, Ve, and Vscan and transfers them to the drivers 300, 400, and 500.

As described above, in the present invention, because the voltage level of the reference voltage Vref is not affected by the change in characteristics of the elements resulting from the aging of the elements when the plasma display is driven for more than a certain time and changes in the external environment, such as temperature or humidity, the accuracy of the driving voltages supplied to the drivers of the plasma display can be guaranteed, and thus, picture quality desired to be implemented by the plasma display can be sustained uniformly.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A controller to supply a driving voltage to drive a plasma panel, the controller comprising:
a power supply including a first switch coupled to a primary of a transformer, the primary of the transformer supplying power to a secondary of the transformer according to an operation of the first switch;
a feedback circuit to generate a feedback signal according to a voltage level of a reference voltage corresponding to a first voltage outputted to an output terminal connected to the secondary of the transformer;
a switching controller to generate a switching control signal to control an ON/OFF operation of the first switch according to the feedback signal; and
a reference voltage controller to compare the voltage level of the reference voltage with a predetermined voltage level and to control the voltage level of the reference voltage according to the comparison result.

2. The controller of claim 1, wherein the reference voltage controller comprises:
a Pulse Width Modulation (PWM) generator to compare the voltage level of the reference voltage with the predetermined voltage level, and to change a duty cycle ratio of an outputted pulse string according to the comparison result;
an integrator to output a DC voltage corresponding to the duty cycle ratio of the pulse string;
a second switch controlled to be turned ON or OFF according to a voltage level of the DC voltage outputted from the integrator, and having one terminal connected to a first point at which a second voltage proportional to the reference voltage is detected;
a first resistor connected between another terminal of the second switch and a ground terminal; and
a second resistor connected between the first point and the ground terminal.

3. The controller of claim 2, wherein the reference voltage controller further comprises:
a first diode having one terminal connected to an output terminal of the PWM generator, the first diode rectifying the pulse string.

4. The controller of claim 2, wherein the PWM generator comprises:
a reference voltage storage unit to store the predetermined voltage;
a comparator to compare the predetermined voltage with the reference voltage and to output a signal according to the comparison result;
a pulse string generator to generate the pulse string; and
a duty cycle ratio controller to change the duty cycle ratio of the pulse string according to the output signal of the comparator.

5. The controller of claim 4, wherein the duty cycle ratio controller increases the duty cycle ratio of the pulse string in response to the predetermined voltage being larger than the reference voltage, and the duty cycle ratio controller reduces the duty cycle ratio of the pulse string in response to the predetermined voltage being smaller than the reference voltage.

6. The controller of claim 4, wherein the integrator comprises:
a third resistor having one end connected to another terminal of the first diode;
a fourth resistor having one end connected to another end of the third resistor and the fourth resistor having another end connected to the ground terminal; and
a first capacitor having one end connected to a second point, the second point being a junction of the third and fourth resistors, and the first capacitor having another end connected to the ground terminal.

7. The controller of claim 6, further comprising:
a fifth resistor having one end connected to the second point and another end connected to a control electrode of the first switch, the fifth resistor canceling noise of an output signal from the integrator and transferring the noise-canceled signal to a control terminal of the first switch.

8. The controller of claim 2, wherein the voltage at the first point increases when the second switch is turned on.

9. The controller of claim 2, wherein the feedback circuit unit comprises:
a sixth resistor having one end connected to the output terminal;
a seventh resistor having one end connected to a junction of the output terminal and the first resistor;
a photodiode having a terminal connected to another end of the seventh resistor;
a phototransistor to transfer the feedback signal corresponding to an amount of current inputted to the photodiode to the switching controller;
a second capacitor having one end connected to another end of the sixth resistor and the second capacitor having another end connected to another terminal of the photodiode;
a shunt regulator having a reference terminal connected to a third point, the third point being a junction of the second capacitor and the first resistor and the shunt regulator having another terminal connected to a junction of the second capacitor and the photodiode; and
an eighth resistor having one end connected to the third point and the eighth resistor having another end connected to still another terminal of the shunt regulator and the first point.

10. The controller of claim 9, wherein the reference voltage is a voltage at the third point.

11. The controller of claim 9, wherein the reference voltage is related to the voltage at the first point.

12. A plasma display comprising:
a Plasma Display Panel (PDP) including a plurality of first electrodes, a plurality of second electrodes, and a plurality of third electrodes formed to cross the first and second electrodes;
first to third drivers to respectively drive the pluralities of first to third electrodes;
a power supply to convert an input voltage to a DC voltage and to generate a plurality of driving voltages to respectively drive the first to third electrodes; and
a controller including a first switching mode power supply unit to supply a control signal to the drivers and to supply a first voltage to the first driver;
wherein the first switching mode power supply unit includes:
a power supply including a first switch coupled to a primary of a transformer, the primary of the transformer supplying power to a secondary of the transformer according to an operation of the first switch;
a feedback circuit to generate a feedback signal according to a voltage level of a reference voltage corresponding to the first voltage outputted to an output terminal connected to the secondary of the transformer;
a switching controller to generate a switching control signal to control an ON/OFF operation of the first switch according to the feedback signal; and
a reference voltage controller to compare the voltage level of the reference voltage with a predetermined voltage level and to control the voltage level of the reference voltage according to the comparison result.

13. The device of claim 12, wherein:
the controller drives the PDP according to a reset period, an address period and a sustain period; and
the first driver supplies the first voltage to a cell of the PDP which is not being addressed during the address period.

14. The device of claim 12, wherein:
the controller further comprises second to Nth switching mode power supply units respectively corresponding to the number of the plurality of driving voltages, the second to Nth switching mode power supply units each being identical to the first switching mode power supply unit;
wherein the controller respectively supplies second to Nth voltages outputted from the second to the Nth switching mode power supply units to the first to third drivers.
